(19) United States
(12) Patent Application Publication
(10) Pub. No.: US 2013/0187054 A1
(43) Pub. Date: Jul. 25, 2013

(54) RADIATION IMAGING APPARATUS AND RADIATION IMAGING SYSTEM

(71) Applicant: CANON KABUSHIKI KAISHA, Tokyo (JP)

(72) Inventors: Takamasa ISHII, Honjo-shi (JP); Masato INOUE, Kumagaya-shi (JP); Shinichi TAKEDA, Honjo-shi (JP); Satoru SAWADA, Fujioka-shi (JP); Taiki TAKEI, Okegawa-shi (JP)

(73) Assignee: CANON KABUSHIKI KAISHA, Tokyo (JP)

(21) Appl. No.: 13/729,512

(22) Filed: Dec. 28, 2012

(30) Foreign Application Priority Data
Jan. 25, 2012 (JP) 2012-013429

(51) Int. Cl. G01T 1/20

(52) U.S. Cl. CPC G01T 1/2006
USPC 250/367

(57) ABSTRACT

A radiation imaging apparatus is provided. The apparatus includes an image sensing panel in which a plurality of imaging substrates each including an photoelectric conversion element are arranged so as to form a single image sensing plane, and a scintillator portion that is disposed in a location covering the image sensing panel, and converts radiation into light having a wavelength detectable by the photoelectric conversion element. The scintillator portion includes, in a location covering at least a region between the plurality of imaging substrates, a first scintillator layer and a second scintillator layer that diffuses the converted light over a wider range than the first scintillator layer does.

### BACKGROUND OF THE INVENTION

1. Field of the Invention

The present invention relates to radiation imaging apparatuses and radiation imaging systems.

2. Description of the Related Art

In recent years, radiation imaging apparatuses having a large area of, for example, 40 cm×40 cm have been developed. Japanese Patent Laid-Open Nos. 2002-48870 and 2002-44522 disclose that, in order to manufacture such large area radiation imaging apparatuses with high yield, a plurality of imaging substrates each including photoelectric conversion elements are arranged so as to form a single image sensing plane. According to these publications, a scintillator having a columnar structure is used as the scintillator that covers the single image sensing plane and converts radiation into light, thereby reducing scattering of the light in the scintillator and achieving improvement in sharpness of an image obtained by the radiation imaging apparatus.

### SUMMARY OF THE INVENTION

In the radiation imaging apparatuses described in the above-mentioned publications, light converted by the scintillator in a location covering a gap between adjacent imaging substrates is guided by the columnar crystal and directly enters the gap. The light that has entered the gap cannot be detected by the photoelectric conversion element. Therefore, image information of a region that corresponds to the gap between the adjacent imaging substrates will be lost from an image obtained by the radiation imaging apparatus. In view of the circumstances, an aspect of the present invention provides a technique for reducing the loss of image information of the gap between adjacent imaging substrates.

An aspect of the present invention provides a radiation imaging apparatus comprising: an image sensing panel in which a plurality of imaging substrates each including an photoelectric conversion element are arranged so as to form a single image sensing plane; and a scintillator portion that is disposed in a location covering the image sensing panel, and converts radiation into light having a wavelength detectable by the photoelectric conversion element, the scintillator portion including, in a location covering at least a region between the plurality of imaging substrates, a first scintillator layer and a second scintillator layer that diffuses the converted light over a wider range than the first scintillator layer does.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram schematically illustrating an example of a configuration of a radiation imaging apparatus according to a first embodiment of the present invention.

FIG. 2 is a diagram illustrating an example of an arrangement of pixels of the radiation imaging apparatus according to the first embodiment of the present invention.

FIGS. 3A-3C are diagrams each illustrating in detail an example of a structure of the radiation imaging apparatus according to the first embodiment of the present invention.

FIG. 4 is a diagram schematically illustrating an example of a configuration of a radiation imaging apparatus according to a second embodiment of the present invention.

FIG. 5 is a diagram illustrating in detail an example of a structure of the radiation imaging apparatus according to the second embodiment of the present invention.

FIG. 6 is a diagram illustrating a radiation imaging system of another embodiment of the present invention.

### DESCRIPTION OF THE EMBODIMENTS

Embodiments of the present invention will now be described with reference to the accompanied drawings. Throughout the various embodiments, the same reference numerals are given to the similar components and duplicated description (thereof) is omitted. The embodiments of the present invention will be described below in the context of a radiation imaging apparatus for use in a medical diagnostic imaging apparatus, an analysis device or the like. In the present invention, light encompasses visible light and infrared rays, and radiation encompasses X-rays, alpha rays, beta rays, and gamma rays.

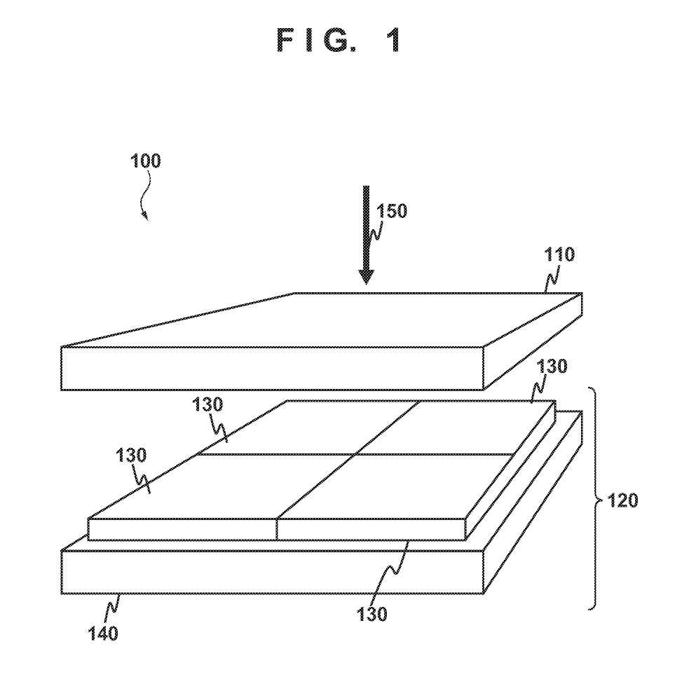

An example of a schematic configuration of a radiation imaging apparatus 100 according to a first embodiment of the present invention will be described, with reference to FIG. 1. The radiation imaging apparatus 100 can includes a scintillator portion 110 and an image sensing panel 120. For illustrative purposes, FIG. 1 depicts that the scintillator portion 110 and the image sensing panel 120 are separated from each other, but in actual fact the scintillator portion 110 and the image sensing panel 120 can be disposed so that they overlap each other, as will be described later. The image sensing panel 120 can include a plurality of imaging substrates 130 and a base 140. The plurality of imaging substrates 130 are arranged and respectively fixed to the base 140 so as to form a single image sensing plane. Each of the imaging substrates 130 includes a plurality of photoelectric conversion elements arranged in a matrix, and functions to detect light and convert the detected light into an electrical signal. As the photoelectric conversion element, a CMOS sensor using crystalline silicon or a PIN-type or MIS-type sensor that uses amorphous silicon can be used. As the imaging substrate 130, any existing configuration capable of detecting light and converting the detected light into an electrical signal can be used. Such configuration is known to a person skilled in the art, and therefore a detailed description thereof will be omitted below.

Radiation exposed toward an object from a direction of an arrow 150 is attenuated by the object and then enters the scintillator portion 110. The scintillator portion 110 converts the radiation into light (for example, visible light) having a wavelength that can be detected by the photoelectric conversion elements. The light converted by the scintillator portion 110 enters the imaging substrates 130 and is converted into an electrical signal. An image is then generated on the basis of the electrical signal. It is also possible to obtain a moving image by the radiation imaging apparatus 100 repeating these operations.

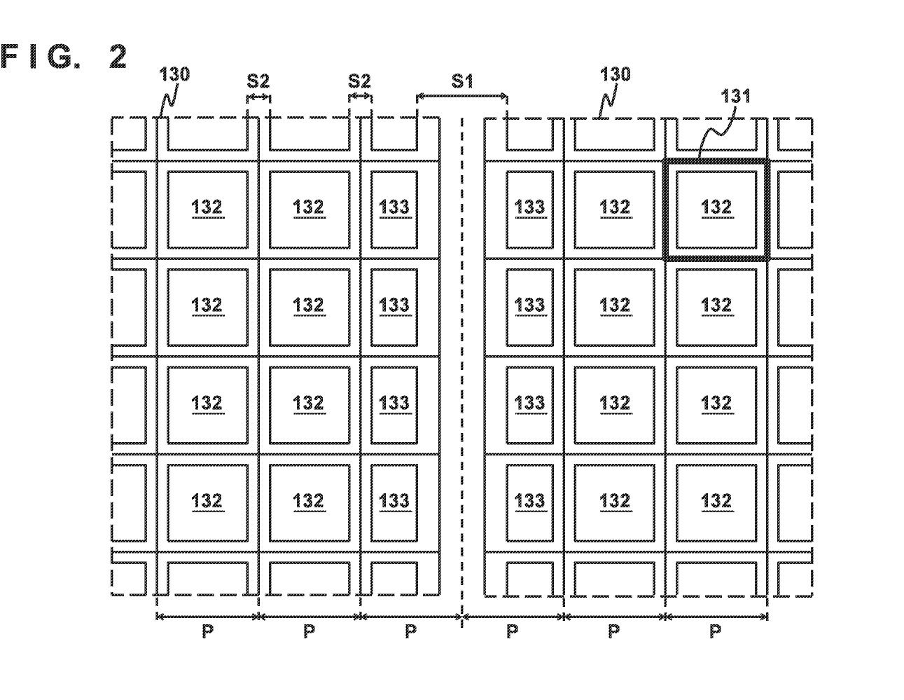

Next, an example of an arrangement of pixels in the imaging substrates 130 of the radiation imaging apparatus 100 will be described, with reference to a plane view of FIG. 2. Each imaging substrate 130 includes a plurality of pixels 131. For illustrative purposes, FIG. 2 depicts outlines of the pixels with a solid line, but in an actual apparatus no such outlines are shown. Each of pixels 131 located in an outer peripheral part of the imaging substrate 130, that is, pixels 131 which abut an edge of the imaging substrate 130 includes a photoelectric conversion element 133, whereas each of other pixels 131 includes a photoelectric conversion element 132. As illustrated in FIG. 2, in the case where a plurality of imaging substrates 130 are arranged so as to form a single image sensing plane, the pixels can be arranged at an equal pixel pitch P over the entire image sensing plane. In order to make the pixel pitches P equal to each other, the photoelectric conversion elements 133 included in the pixels 131 which abut the edge of the imaging substrate 130 can (each) have a smaller area than that of the other photoelectric conversion elements 132, because a gap occurs between the adjacent imaging substrates 130. This allows reduction in distortion or the like of an image obtained by the radiation imaging apparatus 100.

Even though the pixel pitches P are made equal to each other, a width of a region S1 between the photoelectric conversion elements of two pixels 131 that are adjacent across two imaging substrates 130 is greater than that of a region S2 between the photoelectric conversion elements of two pixels 131 which are included in the same imaging substrate 130. Because light that has entered a region, such as the region S1 or S2, where there are no photoelectric conversion elements present is not detected by a photoelectric conversion element, image information of such regions will be lost from an image obtained by the radiation imaging apparatus. According to the present embodiment, the photoelectric conversion elements 132 and 133 can detect light converted by the scintillator portion 110 in locations covering the region S1 and the region S2, as will be described later.

In a case where an image of high resolution is desired, such as with, for example, breast diagnosis, the radiation imaging apparatus 100 can be designed so that the pixel pitch P is less than or equal to 100 um. Due to the accuracy with which imaging substrates are cut and bonded, there is a limit to the reduction in the width of the gap between adjacent imaging substrates 130. Accordingly, the difference in width between the region S1 and the region S2 appears more markedly when the pixel pitch P is smaller.

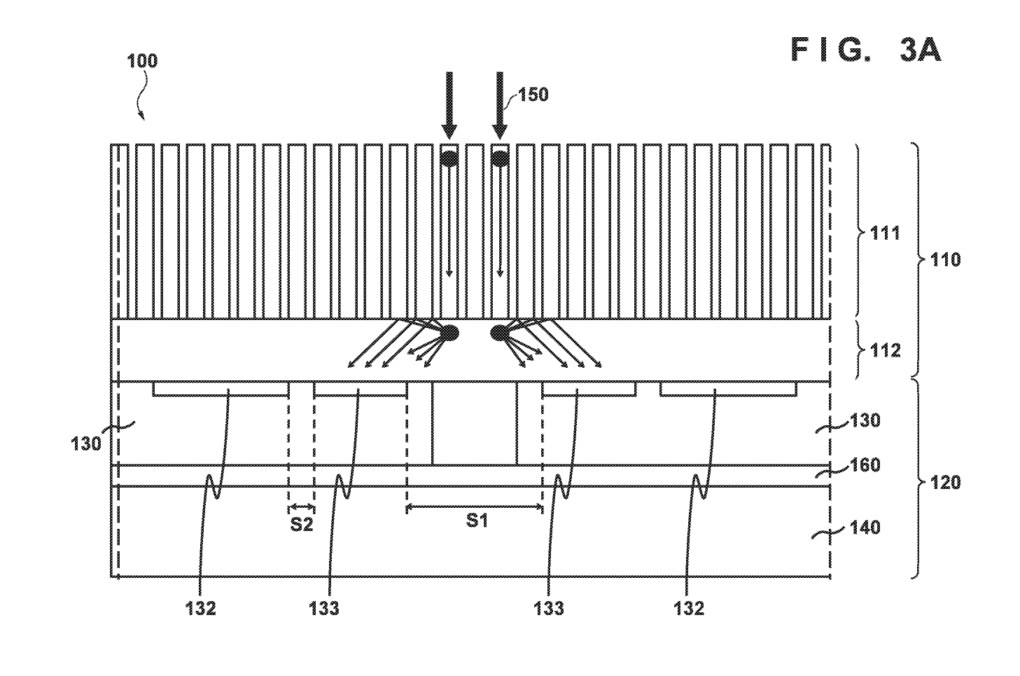

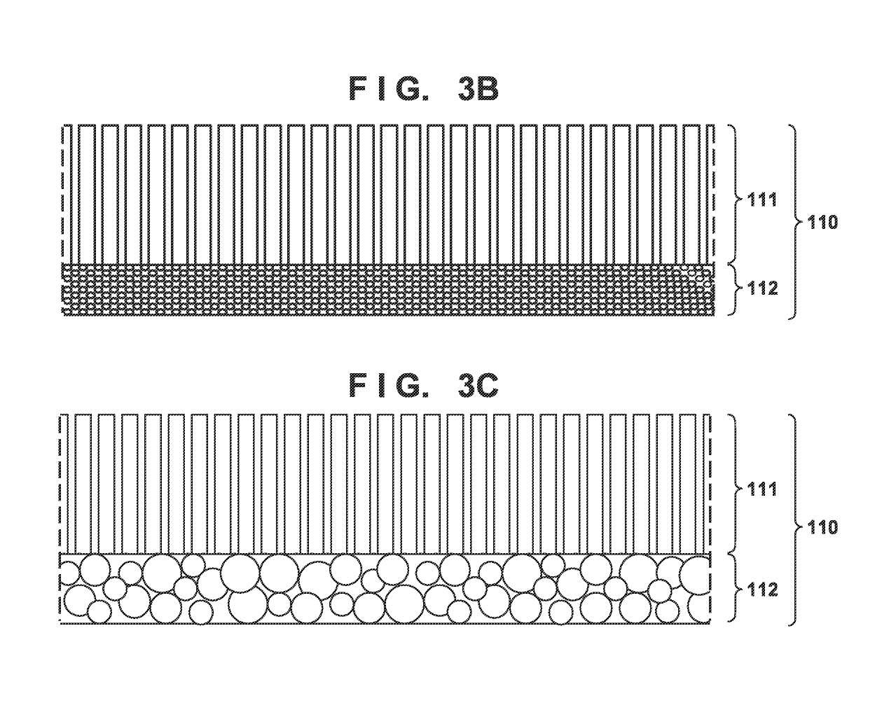

Next, examples of a structure of the radiation imaging apparatus 100 will be described in detail, with reference to cross sectional views of FIGS. 3A-3C. The plurality of imaging substrates 130 are fixed to the base 140 by a connecting member 160, such as an adhesive or a bonding agent. As illustrated in FIG. 3A, the scintillator portion 110 can include a first scintillator layer 111 and a second scintillator layer 112 that diffuses the converted light over a wider range than the first scintillator layer 111. The second scintillator layer 112 is, for example, plate-shaped CsI (cesium iodide) doped with Tl (thallium), and the first scintillator layer 111 is, for example, a set (a columnar structure) of columnar crystals of CsI doped with Tl. Both scintillator layers can be formed by vapor deposition.

In FIG. 3A, circles indicate luminous points in the scintillator portion 110, and arrows extending from the circles indicate directions in which part of the light generated at the luminous point travels. The light emitted in the first scintillator layer 111 travels along the columnar crystals in a direction perpendicular to the image sensing panel 120. On the other hand, the light emitted in the second scintillator layer 112 diffuses radially. Therefore, of the light emitted in the part of the second scintillator layer 112 which covers the region S1, light indicated by the arrows will enter the photoelectric conversion elements 133 which are adjacent to the region S1 and be converted into electrical signals. As such, in the present embodiment, the scintillator portion 110, which covers the region between adjacent imaging substrates 130, includes the second scintillator layer 112, which diffuses light over a wide range, and thus the photoelectric conversion elements 133 can detect the light converted in the region, and the loss of image information can be reduced. Further, the scintillator portion 110 also includes the first scintillator layer 111 having a columnar structure, and thus sharpness of an image can also be maintained.

In the present embodiment, if higher priority is given to improvement in sharpness of an image obtained by the radiation imaging apparatus 100 than reduction in loss of the image information, a ratio of the first scintillator layer 111 in the scintillator portion 110 can be increased. For example, the second scintillator layer 112 can have a thickness that is less than that of the first scintillator layer 111.

In the example of FIG. 3A, the second scintillator layer 112 is arranged closer to the image sensing panel 120 than the first scintillator layer 111 is, but, conversely, the first scintillator layer 111 can be arranged closer to the image sensing panel 120 than the second scintillator layer 112 is. In other words, the second scintillator layer 112 can be arranged between the first scintillator layer 111 and the image sensing panel 120 or the first scintillator layer 111 can be arranged between the second scintillator layer 112 and the image sensing panel 120. In the case where the second scintillator layer 112 is arranged between the first scintillator layer 111 and the image sensing panel 120, the light converted in the second scintillator layer 112 will enter the image sensing panel 120 in a narrower range as compared with the opposite case, thereby improving sharpness of the image. Further, in the example of FIG. 3A, the scintillator portion 110 includes the second scintillator layer 112 in a location covering the entire image sensing panel 120. However, the above-mentioned effect can be achieved, provided that the scintillator portion 110 includes the second scintillator layer 112 in at least a region between adjacent imaging substrates 130. The above-mentioned effect appears more markedly when the second scintillator layer 112, which diffuses light over a wide range, is arranged closer to the image sensing panel 120 than the first scintillator layer 111 is. In a case where the first scintillator layer 111 is arranged closer to the image sensing panel 120 than the second scintillator layer 112 is, light emitted in the part of the first scintillator layer 111 which corresponds to the region between the imaging substrates 130 can pass through the region between the adjacent imaging substrates 130. In contrast, in a case where the second scintillator layer 112 is arranged closer to the image sensing panel 120 than the first scintillator layer 111 is, both light emitted in the part of the first scintillator layer 111 which corresponds to the region between the adjacent imaging substrates 130 and light emitted in the part of the second scintillator layer 112 which corresponds to the region between the adjacent imaging substrates 130 can be diffused. It is thus possible to achieve more reduction in the amount of light that can pass through the region between the adjacent imaging substrates 130, in the case where the second scintillator layer 112 is arranged closer to the image sensing panel 120 than the first scintillator layer 111 is.

As illustrated in FIG. 3B, the second scintillator layer 112 may be formed on the image sensing panel 120 by applying a mixture of CsI powder of and a resin, and then a first scintillator layer 111 having a columnar structure may be formed by vapor depositing CsI directly on the second scintillator layer 112. Alternatively, as illustrated in FIG. 3C, the second scintillator layer 112 may be formed on the image sensing panel 120 by applying a mixture of granular GOS (gadolinium oxysulphide) and a resin, and then a first scintillator layer 111 having a columnar structure may be formed by vapor depositing CsI directly on the second scintillator layer 112.

In a case where the scintillator portion 110 is made from CsI, the luminescence characteristics of the scintillator portion 110 vary in accordance with the concentration of Tl with which the CsI is doped. Accordingly, the concentration of Tl in the second scintillator layer 112 may be higher than the concentration of Tl in the first scintillator layer 111, in order to increase an amount of luminescence in the vicinity of the photoelectric conversion elements and to improve the sensitivity of the imaging substrates 130.

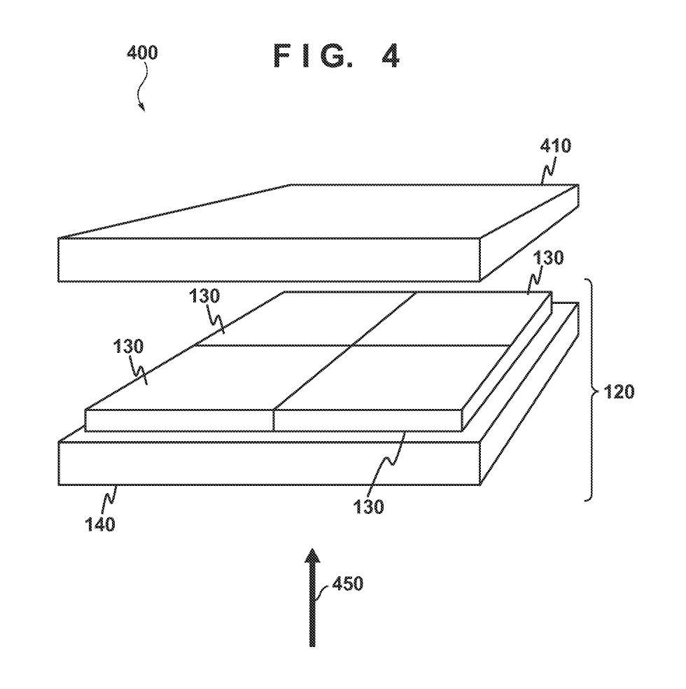

Next, an example of a schematic configuration of a radiation imaging apparatus 400 according to a second embodiment of the present invention will be described, with reference to FIG. 4. The various modifications described in the first embodiment are also applicable to the present embodiment. The radiation imaging apparatus 400 can have the same configuration as that of the radiation imaging apparatus 100, except that the radiation imaging apparatus 400 detects radiation that has entered from a direction of an arrow 450. Further, the radiation imaging apparatus 400 can include a scintillator portion 410, instead of the scintillator portion 110. The radiation imaging apparatus 400 can employ an imaging substrate 130 whose thickness is, for example, of the order of several hundred μm, so that radiation can pass through the imaging substrate 130. Further, the radiation imaging apparatus 400 can employ, as a base 140, a material that absorbs little radiation, such as a carbon base. Alternatively, the radiation imaging apparatus 400 can employ, as a base 140, a thin glass substrate or an aluminum substrate.

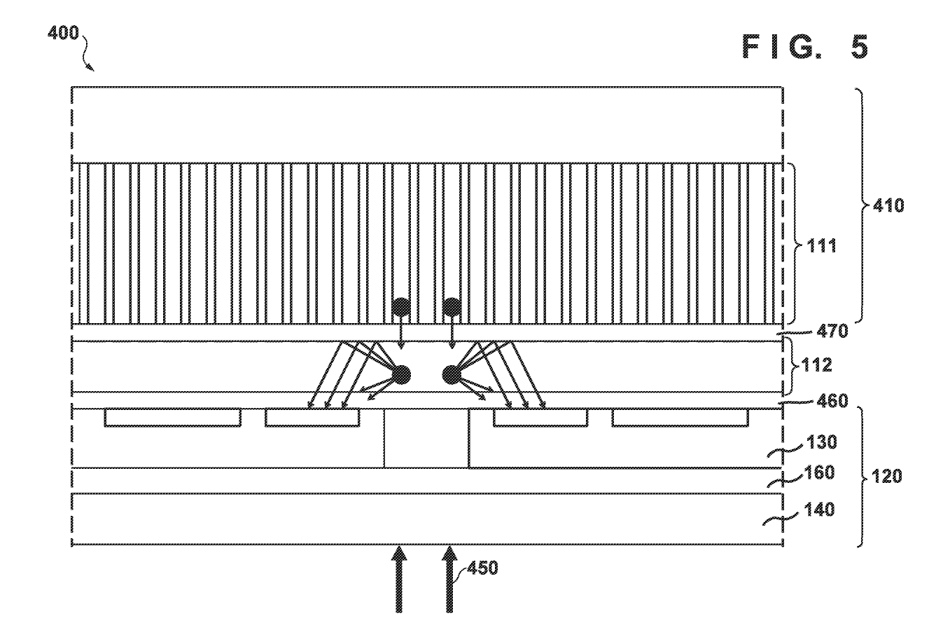

Next, an example of a structure of the radiation imaging apparatus 400 will be described in detail, with reference to a cross section of FIG. 5. Similar to the scintillator portion 110, the scintillator portion 410 can include a first scintillator layer 111 and a second scintillator layer 112. The scintillator layers have the same functions as those of the scintillator layers described in the first embodiment, and duplicated description (thereof) will be omitted below. The image sensing panel 120 and the second scintillator layer 112 are bonded to each other with a connecting member 460, and the second scintillator layer 112 and the first scintillator layer 111 are bonded to each other with a connecting member 470. The connecting members 460 and 470 can be an adhesive or a bonding agent.

In the radiation imaging apparatus 400, radiation that has entered from a direction of the arrow 450 will first enter the second scintillator layer 112, and residual radiation remained unconverted in the second scintillator layer 112 will enter the first scintillator layer 111. Therefore, more radiation is converted into light in the second scintillator layer 112, compared with the radiation imaging apparatus 100. Consequently, the radiation imaging apparatus 400 can detect image information of the region between the adjacent imaging substrates 130 with higher sensitivity, compared with the radiation imaging apparatus 100.

In general, a scintillator absorbs more radiation and converts it into light the closer it is to the side on which the radiation enters, provided that the scintillator has a uniform film quality. Accordingly, in a case where radiation is emitted toward the side where the image sensing panel 120 is disposed, as with the present embodiment, much of the radiation is converted into light in the vicinity of the photoelectric conversion elements, leading to improvement in sensitivity across the entire surface of the imaging substrates 130. Furthermore, since the luminous points are located in the vicinity of the photoelectric conversion elements, it is possible to suppress light from unnecessarily entering the photoelectric conversion elements, and thereby achieve improvement in sharpness of an image.

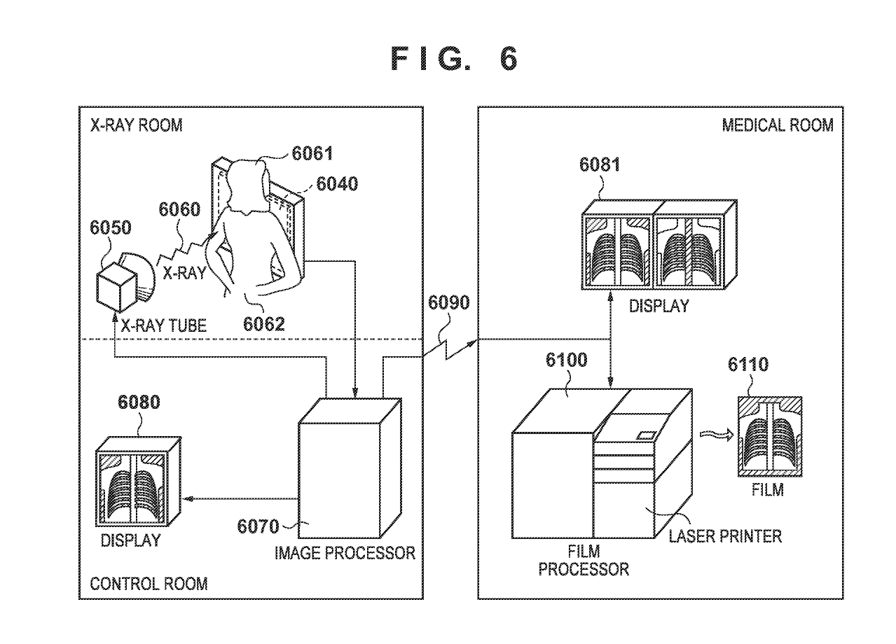

FIG. 6 is a diagram illustrating an example in which a detection apparatus for detecting radiation according to the present invention is applied to a diagnostic X-ray system (radiation imaging system). X-rays 6060 serving as radiation generated by an X-ray tube 6050 (radiation source), passes through a chest 6062 of a test subject or a patient 6061, and enters a detection apparatus 6040 of the present invention in which a scintillator including the scintillator portion 110 or 410 is disposed in the upper part of the detection apparatus. The detection apparatus provided with the scintillator disposed in the upper part thereof configures a detection apparatus for detecting radiation. The X-rays that have entered the detection apparatus include information on the body of the patient 6061. The scintillator emits light in accordance with the entering of the X-rays. The emitted light is photoelectrically converted, and electrical information is obtained. This information is converted into a digital signal and subjected to image processing by an image processor 6070, which serves as a signal processing means, and the image processed information can be observed on a display 6080, which serves as a display means, in a control room. Note that the radiation imaging system includes at least the detection apparatus and the signal processing means for processing signals from the detection apparatus.

The information can also be transmitted to a remote location via a transmission processing means, such as a phone line 6090, and displayed on a display 6081, which serves as a display means, in a medical room or the like in another place or stored in a recording means, such as an optical disk, enabling a physician in the remote location to make a diagnosis. The information can also be recorded on a film 6110, which serves as a recording medium by a film processor 6100, which serves as a recording means.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-013429, filed Jan. 25, 2012, which is hereby incorporated by reference herein in its entirety.

What is claimed is:

1. A radiation imaging apparatus comprising:
an image sensing panel in which a plurality of imaging substrates each including an photoelectric conversion element are arranged so as to form a single image sensing plane; and
a scintillator portion that is disposed in a location covering the image sensing panel, and converts radiation into light having a wavelength detectable by the photoelectric conversion element,
the scintillator portion including, in a location covering at least a region between the plurality of imaging substrates, a first scintillator layer and a second scintillator layer that diffuses the converted light over a wider range than the first scintillator layer does.

2. The apparatus according to claim 1,
wherein the second scintillator layer is disposed between the first scintillator layer and the image sensing panel.

3. The apparatus according to claim 1,
wherein the second scintillator layer has a thickness that is less than a thickness of the first scintillator layer.

4. The apparatus according to claim 1,
wherein the first scintillator layer includes a set of columnar crystals of cesium iodide, and the second scintillator layer includes cesium iodide powder.

5. The apparatus according to claim 4,
wherein thallium with which the second scintillator layer is doped has a concentration that is higher than a concentration of thallium with which the first scintillator layer is doped.

6. The apparatus according to claim 1,
wherein the first scintillator layer includes a set of columnar crystals of cesium iodide, and the second scintillator layer includes granular gadolinium oxysulphide.

7. A radiation imaging system comprising:
a radiation imaging apparatus according to claim 1; and
a signal processing unit configured to process a signal obtained by the radiation imaging apparatus.
